(19) United States
(12) Patent Application Publication
(10) Pub. No.: US 2005/0166742 A1
(43) Pub. Date: Aug. 4, 2005

(54) Mitre box for coving

(76) Inventors: John Raymond Collins, Gwent (GB); John William Collins, Gwent (GB)

Correspondence Address: JOHN RAYMOND COLLINS AND JOHN WILLIAM COLLINS, c/o 3627 Huerta Drive, Las Vegas, NV, 89121, US

(21) Appl. No.: 11/050,008

(22) Filed: Feb. 2, 2005

Related U.S. Application Data
(60) Provisional application No. 60/541,739, filed on Feb. 4, 2004.

(51) Int. Cl. B26D 5/08; B27B 11/00

(52) U.S. Cl. 83/762; 83/581; 83/821

(57) ABSTRACT

A mitre box for coving including a base, and a pair of opposing side walls, the sidewalls including one or more sawing slots, the box further including at least two pairs of abutment portions, wherein the distance between the first pair of abutment portions substantially corresponds to a first predefined width-from-wall dimension of a section of coving, and the distance between the second pair of abutment portions substantially corresponds to a second predefined width-from-wall dimension of another section of coving.

### CROSS REFERENCE TO RELATED APPLICATIONS

I hereby claim benefit under Title 25, United States Code, Section 119 (e) of U.S. provisional patent application Ser. No. 60/541,739 on Feb. 4th, 2004. The application Ser. No. 60/541,739 is hereby incorporated by reference into this application.

### BACKGROUND OF THE INVENTION

1. Field of Invention

The present invention relates to a mitre box.

2. Description of the Prior Art

Conventional mitre boxes comprise a flat rectangular base having two upstanding opposing sidewalls. The sidewalls typically include one or more slots that act as a guide for a saw when it is used to cut through an article such as a section of coving placed in the mitre box. The slots typically include one for making straight or butt-joint cuts, as well as two 45 degree slots for meeting internal and external corners.

GB2366621 (Freeland) issued 13^{th} Mar. 2002 titled “Adjustable mitre cutting apparatus for coving, skirting boards has pair of adjustable workpiece locating units having a base plate and a pair of vertical support surfaces” discloses an apparatus which includes a pair of adjustable workpiece locating units having a base plate with vertical lips, and a pair of vertical support surfaces. The locating unit position is adjusted such that the vertical support surfaces subtend at an acute angle and substantially align with the base plate. A gap is formed between the forward edge of the vertical support surfaces and saw line.

GB2339478 (Eaves) issued 26^{th} Jan. 2000 titled “Coving mitre cut guide” discloses a guide has two bases joined at an angle by a hinge lock which allows the angle to be altered and fixed. Saw cutting guides are mounted on the bases for controlling the path of the saw. The coving is supported by coving wall edge support stanchions, coving edge securing pegs and a series of round apertures into which the pegs are inserted.

EP160499 (Dodkin, Twigger) issued 6^{th} Nov. 1985 titled “Guide for coving cutter—has notches for positioning on coving and guide face for saw” discloses a guide that has a guide face for sliding engagement by a cutter at the required angle of cut. The guide face can be positioned to give a 45 degree angle of cut. There can be a second guide face for sliding engagement by a cutter, to allow secondary cutting at a different angle. The guide can be made of sheet metal and have notches to engage the coving to orient it with respect to the coving.

GB2123743 (Smith) issued 8^{th} Feb. 1984 titled “Mitre block for ceiling cove—has saw guides at specified angles for work supported on base” discloses a block that has saw guides to enable coving to be cut by placing it face down on a base. The plane of the cut is at approximately 55 degrees, preferably 54.7 degrees, to the base and walls when measured in the plane of a wall and the base respectively. Alternatively the saw guides located one on each side of a base are adjustable longitudinally of the base and are pivotable relative to the base. The guides may be pivotally mounted on a plate which is rotatable in the plane of the base, to alter the angle of cut across the base.

Existing mitre boxes are produced in a range of standard sizes that correspond to the widths of commercially available coving. If the mitre box is too large for the width of the coving being cut then there is a risk that the coving will slip as it is being sawn. This means that if coving of several different sizes is to be cut then more than one mitre box needs to be purchased.

Further, the way in which coving is positioned for cutting in conventional mitre boxes is felt to be counterintuitive by many users. This is because the coving is held in an ‘upside down’ orientation (i.e. with part of the coving lying along the bottom of the mitre box) compared with the in-situ position of the coving (i.e. with a portion of the coving extending along an overhead ceiling). This means that there is a risk that a user will not notice until it is too late if he is accidentally making a cut in the wrong position on the coving.

### SUMMARY OF THE INVENTION

Embodiments of the present invention are intended to provide a mitre box that addresses the problems discussed above.

According to a first aspect of the present invention there is provided a mitre box for coving including:
a base, and
a pair of opposing side walls, the sidewalls including one or more sawing slots,
the box further including at least two pairs of abutment portions, wherein the distance between the first pair of abutment portions substantially corresponds to a first predefined width-from-wall dimension of a section of coving, and the distance between the second pair of abutment portions substantially corresponds to a second predefined width-from-wall dimension of another section of coving.

In use, one edge of a section of coving abutting one abutment portion of one said pair, the other edge of the coving abutting the other abutment portion of the pair such that the coving is substantially prevented from moving horizontally between the sidewalls of the box.

The width-from-wall dimension can be considered to be the distance between a surface of the coving that contacts a wall when it is installed and the edge of the coving remote from the contact point.

In some embodiments one of the sidewalls of the box may form at least one of the abutment portions.

In one embodiment one abutment portion of the first pair is formed by the internal surface of one said sidewall and the other abutment portion of the first pair is formed by the internal surface of the opposing said firewall. One abutment portion of the second pair may be formed by a portion projecting from the base of the box adjacent one said sidewall and the other abutment portion of the second pair is formed by the internal surface of the opposing said firewall. The abutment portion projecting from the base of the box may be a substantially rectangular block fitted to or formed along the length of the box within the internal corner formed between the base and the adjacent sidewall.

In another embodiment one abutment portion of the first pair is formed by the internal surface of a said sidewall and the other abutment portion of the first pair is formed by the internal surface of the opposing said sidewall. One abutment portion of the second pair may be formed by a portion projecting from one said sidewall and the other abutment portion of the second pair is formed by the internal surface of the opposing said firewall. Either or both said sidewalls may include one or more cut-out portions. In one embodiment the cut-out is located at a substantially central point along the sidewall. One of the pair of saw slots may be used for cutting a left-hand cut and the other slot may be used for cutting a right-hand cut. The cut-out may be located between such a pair of saw slots. Thus, when a section of coving is fitted into the mitre box the user and use the cut-out to see the saw cutting through part of the surface of the coving that will be visible when it is installed.

The box can include one or more markers/indicators for assisting a user in cutting the coving correctly. For example, the base and/or sidewall can have a line or the like which can be used for aligning the correct part of a section of coving that is to be cut. The box may include one or more portions which restrict the space inside the box (or defines the interior surface of the box) such that, in use, at least part of the surface of a section of coving that is intended to be in contact with a wall/ceiling cannot lie on the base of the box. Alternatively and/or additionally, the interior of the box may be dimensioned such that, in use, at least part of the surface of a section of coving that is intended to be in contact with a wall/ceiling cannot lie on the base of the box. Thus, at least part of the coving can be seen by the user in substantially the same orientation when placed in the mitre box as when the coving is fitted between,a wall and a ceiling. The portion may be formed integrally within the box or it may be a separate piece that can be fitted to (the inside of) the box.

The portion may be substantially quadrant-shaped and located between a corner formed between the sidewall and the base. The quadrant-shaped portion may extend form one end of the mitre box to its other end, or the portion may extend from one end of the box to an edge of the cut-out. The quadrant-shape portion may have a curved surface that generally corresponds to the concave surface of the coving or correspond to any particular shape of the coving. This can help a user clearly and quickly see how the coving should be placed in the box. This quadrant shaped portion, which may not necessarily be quadrant shaped but substantially corresponds to the profile of the users coving, also acts as a support to the coving whilst being cut, enabling the user to cut the coving in an in-situ ‘upright position’, offering the user a true perspective.

In one embodiment where one abutment portion of the second pair is formed by a portion projecting form one side wall, the projection may be located above the space-restricting portion.

The box may further include a lip portion extending substantially perpendicularly from the top of one of the sidewalls towards the other sidewall. The lip portion may be integral with other parts of the box, or it may be separate and attached by means of, e.g. bolts. The lip portion may extend to a point around one-third to one-quarter across the width of the box. A lower/side surface of the lip portion may be shaped so as to generally follow the shape of a convex surface of a section of coving that is placed in the mitre box. Such a lip portion can help a user visualise the coving in situ between a ceiling and a wall.

The box may include instructions and/or diagrams. These may be printed directly onto a surface of the box, or they may be on a sheet or the like that is attached to the box. The distance between the abutment portions of the first pair may substantially correspond to a width-to-wall dimension of 125 mm. The distance between the abutment portions of the second pair may substantially correspond to a width-to-wall dimension of 100 mm. The box may be formed of one or more piece of material such as wood, metal or plastic. According to another aspect of the invention there is provided a mitre box for coving including a base and a pair of opposing side walls, the sidewalls including one or more sawing slots and one of the sidewalls having a cut-out portion, the box further including one or more portion which restricts the space inside the box such that, in use, at least part of the surface of a section of coving that is intended to be in contact with a wall/ceiling cannot lie on the base of the box.

According to another aspect of the invention there is provided a mitre box for coving including a base and a pair of opposing side walls, the sidewalls including one or more sawing slots and one of the sidewalls of the box having a cut-out portion, wherein the interior of the box is dimensioned such that, in use, at least part of the surface of a section of coving that is intended to be in contact with a wall/ceiling cannot lie on the base of the box.

Whilst the invention has been described above, it extends to any inventive combination of the features set out above or in the following description.

### BRIEF DESCRIPTION OF THE DRAWINGS

The invention may be performed in various ways, and, by way of example only, embodiments thereof will now be described, reference being made to the accompanying drawings, in which:

FIG. 1 is a schematic perspective view of a mitre box according to one embodiment of the present invention and illustrating how it can be used with different sections of coving;

FIG. 2 is a schematic side view of the mitre box of FIG. 1;

FIG. 3 is a schematic perspective view of an alternative embodiment of the mitre box, and

FIG. 4 is a schematic side view of the mitre box of FIG. 3.

### DESCRIPTION OF THE PREFERRED EMBODIMENT

In the figures the mitre box 100 is shown housing two pieces of coving. Normally, only one piece of coving will be fitted in the mitre box at a time, but the figures illustrate how covings of different sizes are intended to be positioned in the box.

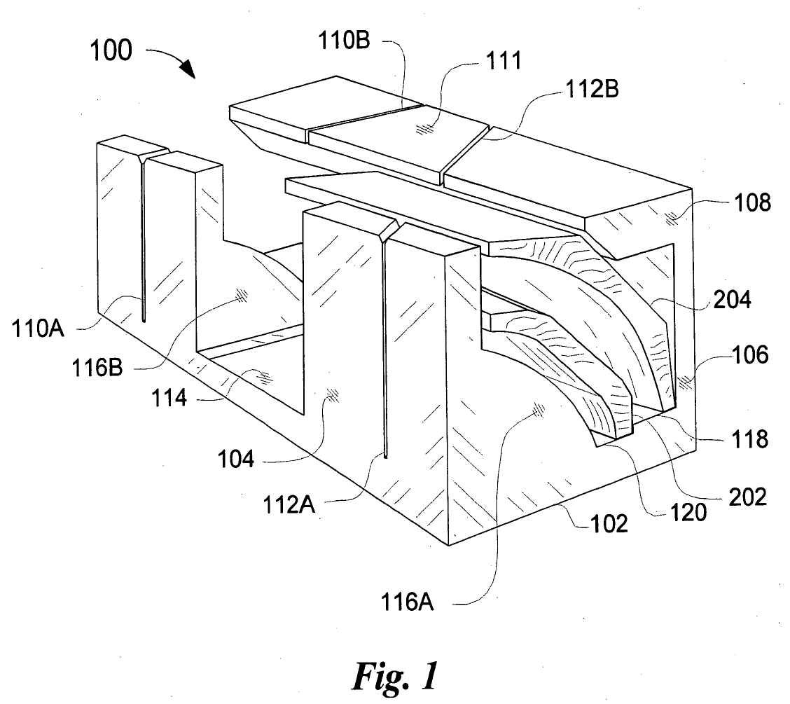

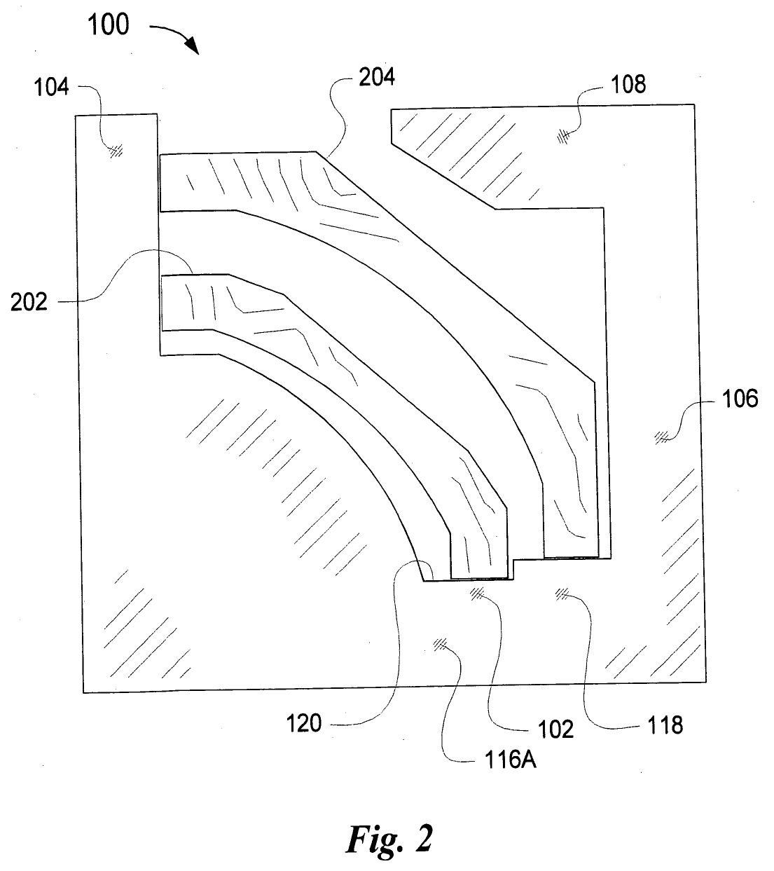

The mitre box 100 includes a flat rectangular base 102. Upstanding perpendicularly from the left-hand side (in FIGS. 1 and 2) of the base 102 is a first sidewall 104 and a parallel, opposing second sidewall 106 extends upwardly from the other side of the base 102. Extending perpendicularly from the top of the second sidewall 106 is a lip portion 108. The lip 108 extends towards the opposing sidewall 104 to a point around one quarter to one third of the way across the width of the base 102. Part of the lower surface of the edge of the lip 108 remote from the second side wall 106 is angled around 45 degrees to the horizontal.

As with conventional mitre boxes, the sidewalls 104,106 include sawing slots. In the example of FIG. 1, there is a left-hand 45 degree cut sawing slot formed by slot 110A in the sidewall 104 and by slot 110B in the opposing sidewall 106. There is also a right-hand 45 degree cut sawing slot formed by slot 112A in the sidewall 104 and by slot 112B in the opposing sidewall 106. The lip 108 is not found in known mitre boxes but the slots 110B, 112B also extend across in the lip. In an alternative embodiment, instead of having slots 110B, 112B in the lip portion with a section 111 of the lip portion extending between the pair of slots, the section 111 of the lip 108 may not be present, with the slanted edges of the lip portions acting as a saw guide.

The first sidewall 104 includes a U-shape cut out portion 114 located at a substantially central position along the length of the mitre box, between the two slots 110A, 112B that extends all the way up from the base 102 of the box to the top of the sidewall 104. It will be appreciated that cut-out 114 is exemplary only and that one or more aperture of alternative shape, dimensions and/or location could be formed in the mitre box which would also provide the functionality of the cut-out as described below.

In the internal corner formed between the first sidewall 104 and the base 102 there is a substantially quadrant-shaped portion 116A (having its arc-shaped profile exposed and its two perpendicular flat surfaces on the sidewall 104 and base 102, respectively) that runs from one end of the mitre box to an adjacent edge of the aperture 114. Similarly, a similar quadrant-shaped portion 116B is formed along the base of the box from the other edge of the aperture 114 to the other end of the box. It will be understood that the shape of the portions 116A, 116B can be varied so that they correspond to the profile of a particular type of coving. It is also possible that the portions 116A, 116B could be removable from the mitre box so that other portions having shapes suitable for different types of coving could be used with the box.

In the internal corner formed between the second sidewall 106 and the base 102 there is a rectangular block 118 that runs from one end of the box 100 to the other end. As can best be seen in FIG. 2, a substantially flat channel 120 is formed on the upper surface of the base 102 is defined by the side of the quadrant-shaped portions 116A, 116B and the other sidewall of the channel is defined by the sidewall of the block portion 118. Thus, the surface of the channel 120 and the block 118 form a step adjacent the sidewall 106. A 120 mm section of coving 202 is fitted with one edge of the coving abutting the first sidewall 104 at a point above the upper surface of the quadrant-shaped portions 116A, 116B. The other edge of the coving rests on the base 102 and abuts the sidewall of the block 118, i.e. it generally fits into the corner formed between these two surfaces 102, 118.

A 125 mm section of coving 204 is fitted with one edge of the coving abutting the first sidewall 104 near the upper end of the sidewall. The other edge of the coving rests on the upper surface of the block 118 and abuts the second sidewall 106, i.e. it generally fits into the corner formed between these two surfaces 118, 106.

Thus, sections of coving of different sizes can be substantially restrained from moving between the sidewalls of the mitre box and secured for sawing. It will be appreciated that mitre boxes according to other embodiments of the invention can be formed with different internal abutment points (which need not necessarily be in contact with the sidewalls) to allow different sizes of coving to be secured by the box. Further, mitre boxes can be produced with a variety of abutment points that allow more than two different sizes of coving to be accommodated.

The presence of the quadrant-shaped portions 116A, 116B means that the coving can only be easily inserted into the mitre box in an orientation where the surfaces of the coving which, when installed, are normally in contact with a wall or ceiling, are not in contact with the lower surface of the box. The curved surfaces of the portions 116A, 116B also generally correspond to the concave surface of the coving and so help a user quickly and clearly see how the coving should be placed in the box. In the example of FIG. 2, the angled lower surface of the lip portion 108 also generally corresponds to the shape of the convex surface of the coving, particularly for the 125 mm section 204, and again this can help prevent a user form inserting the coving into the mitre box the wrong way around. The concave surface of the coving faces the first sidewall 104 and so can be viewed through the cut-out 114. Normally, the user will position himself adjacent the sidewall 104 so that when he is sawing he can view the coving in substantially the same orientation as it would be when positioned between a ceiling and a wall. The lip 108 can also help with this visualisation of the coving in situ. Having the cut-out 114 located between the two sets of sawing slots means that the user can see the coving being sawn when either of the slots is being used.

The mitre box can have markings and/or instructions that are intended to help the user identify how to use it. For example, wording may be positioned adjacent the saw slots 112A, 112B respectively, so as to identify the slots as the saw guides for right-hand cuts. Similar markings can also be positioned adjacent other saw slots. Instructions for using the mitre box can be printed or presented in some other way (e.g. printed on an affixed sheet) on the mitre box. A convenient location for such instructions is on the interior sidewall 106 and/or on part of the base 102 adjacent the aperture 114. This is also a convenient location for including marker lines. A marker line for the right-hand cut can, for example, extend across the width of the base 102 from a point adjacent the bottom of the saw slot 112B. A left-hand marker line can be similarly positioned adjacent the saw slot 110B. The user can make a mark on the coving corresponding to where it is to be cut and then align the mark with the appropriate marker line when it is placed in the box.

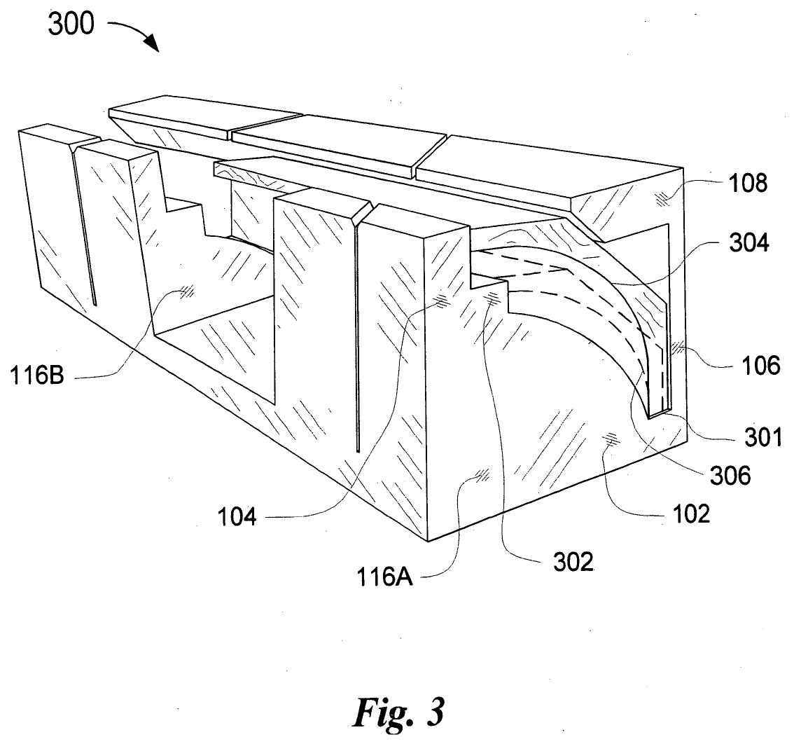

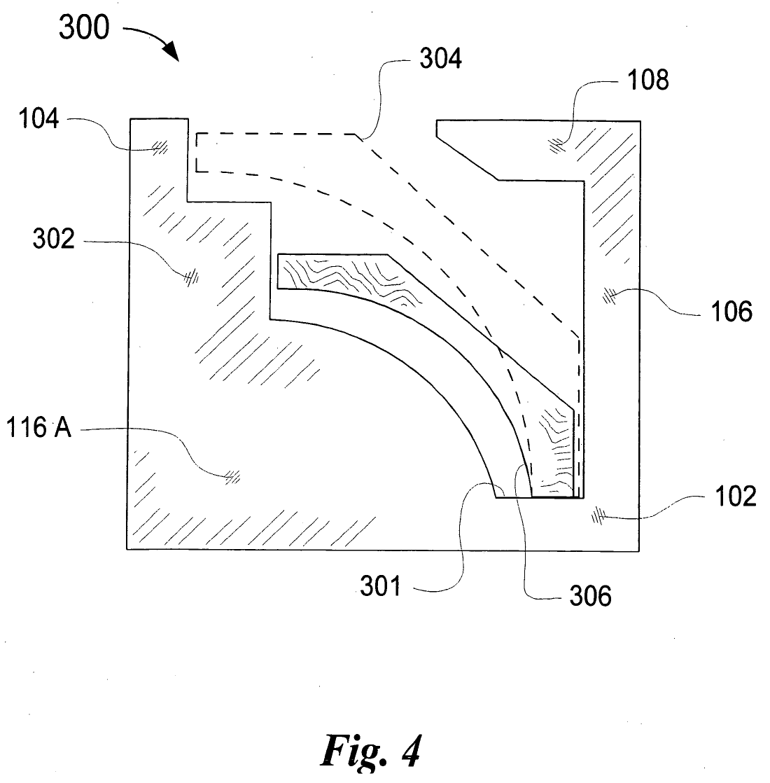

Turning to FIGS. 3 and 4 the mitre box 300 differs to the embodiment 100 of the proceeding figures by not having a block 118 in the corner between the base 102 of the box and the sidewall 106. Portions of the box 300 corresponding to those of the box 100 are given the same reference numerals. A flat channel 301 runs between the edge of the quadrant-shaped portion 116A and the sidewall 106. Instead of the block 118, a rectangular block portion 302 projects from the sidewall 104 at a point above the top of the quadrant-shaped portion 116A. It will be understood that two block portions will usually be provided (similar to the quadrant-shaped portions 116A, 116B) so that a single block does not cross the aperture 114. It will also be understood that the block portion 302 need not actually be formed as part of/connected to the sidewall 104, e.g. it could be attached to/be integral with the substantially quadrant-shaped portion underneath.

In use, a 125 mm section of coving 304 is fitted with one edge of the coving 304 abutting the first sidewall 104 near the upper end of the sidewall and above the upper surface of the block portion 302. The other edge of the coving rests on the base 102 and abuts the sidewall 106, i.e. it generally fits into the corner formed between these two surfaces 102,118.

A 120 mm section of coving 306 is fitted with one edge of the coving abutting the side of the block portion 302, with a gap existing between the lower surface of the coving and the upper surface of the section 116A. The other edge of the coving 306 rests on the base 102 and abuts the sidewall of the block 118, i.e. it also generally fits into the corner formed between these two surfaces 102,118.

It will be appreciated that the shape of the mitre box can be varied such that the points at which the coving contacts (and/or is supported by) the interior of the box can differ to the embodiments shown in the diagrams. Also, the thickness of a particular type of coving can differ from manufacturer to manufacturer and so in some cases surfaces of the coving may contact parts of the mitre box in a different manner to the examples shown in the figures.

The mitre box in the examples described above is formed of a single piece of moulded plastic. However, it will be appreciated that other materials such as metal or wood, or a combination of materials can be used. Further, the box may comprise of several pieces (e.g. the portions 108, 116, 118 could be non-integral and removable) that are assembled together.

It should also be noted that if the mitre box was designed for one size of coving then no block portion 118/302 would be needed and the coving would fit between the pairs of abutment portions.

A dust channel (not shown) could be cut into the base 102 alongside sidewall 106 to allow for the removal of dust.

As with known mitre boxes a straight cut slot can also be provided at allow cuts to be made in the coving at 90 degrees.

1. A mitre box for coving including a base, and a pair of opposing side walls, the sidewalls including one or more sawing slots, the box further including at least two pairs of abutment portions, wherein the distance between the first pair of abutment portions substantially corresponds to a first predefined width-from-wall dimension of a section of coving, and the distance between the second pair of abutment portions substantially corresponds to a second predefined width-from-wall dimension of another section of coving.

2. A mitre box according to claim 1 in which one edge of a section of coving abuts one abutment portion of one said pair, the other edge of the coving abuts the other abutment portion of the pair such that the coving is substantially prevented from moving horizontally between the sidewalls of the box.

3. A mitre box according to claim 1 wherein one of the sidewalls of the box may form at least one of the abutment portions.

4. A mitre box according to claim 1 wherein one abutment portion of the first pair is formed by the internal surface of one said sidewall and the other abutment portion of the first pair is formed by the internal surface of the opposing said firewall.

5. A mitre box according to claim 1 in which one abutment portion of the second pair is formed by a portion projecting from the base of the box adjacent one said sidewall and the other abutment portion of the second pair is formed by the internal surface of the opposing said firewall.

6. A mitre box according to claim 1 wherein the abutment portion projecting from the base of the box is substantially a rectangular block fitted to or formed along the length of the box within the internal corner formed between the base and the adjacent sidewall.

7. A mitre box according to claim 1 in which one abutment portion of the first pair is formed by the internal surface of a said sidewall and the other abutment portion of the first pair is formed by the internal surface of the opposing said firewall.

8. A mitre box according to claim 1 in which one abutment portion of the second pair may be formed by a portion projecting from one said sidewall and the other abutment portion of the second pair is formed by the internal surface of the opposing said firewall.

9. A mitre box according to claim 1 in which either or both said sidewalls may include one or more cut-out portions.

10. A mitre box according to claim 9 in which the cut-out is located at a substantially central point along the sidewall.

11. A mitre box according to claim 1 in which one of the pair of saw slots may be used for cutting a left-hand cut and the other slot may be used for cutting a right-hand cut and the cut-out is located between such a pair of saw slots such that when a section of coving is fitted into the mitre box the user can use the cut-out to see the saw cutting through part of the surface of the coving that will be visible when it is installed.

12. A mitre box according to claim 1 in which the box can include one or more markers/indicators for assisting a user in cutting the coving correctly.

13. A mitre box according to claim 1 in which the box includes one or more portions which restrict the space inside the box (or defines the interior surface of the box) such that, in use, at least part of the surface of a section of coving that is intended to be in contact with a wall/ceiling cannot lie on the base of the box.

14. A mitre box according to claim 13 in which alternatively and/or additionally, the interior of the box may be dimensioned such that, in use, at least part of the surface of a section of coving that is intended to be in contact with a wall/ceiling cannot lie on the base of the box so that at least part of the coving can be seen by the user in substantially the same orientation when placed in the mitre box as when the coving is fitted between a wall and a ceiling.

15. A mitre box according to claim 1 in which one abutment portion of the second pair is formed by a portion projecting form one side wall, the projection may be located above the space-restricting portion.

16. A mitre box according to claim 1 in which the box further includes a lip portion extending substantially perpendicularly from the top of one of the sidewalls towards the other sidewall, the lip portion may be integral with other parts of the box, or it may be separate and attached by means of, e.g. bolts.

17. A mitre box for coving according to claim 1 in which the box further includes one or more portion which restricts the space inside the box such that, in use, at least part of the surface of a section of coving that is intended to be in contact with a wall/ceiling cannot lie on the base of the box.

18. A mitre box for coving according to claim 1 in which the interior of the box is dimensioned such that, in use, at least part of the surface of a section of coving that is intended to be in contact with a wall/ceiling cannot lie on the base of the box.
